(19) United States
(12) Patent Application Publication
(10) Pub. No.: US 2017/0134962 A1
(43) Pub. Date: May 11, 2017

(54) POINT TO MULTI POINT MULTIPLEXING

(71) Applicant: California Internet L.P., Ventura, CA (US)

(72) Inventor: Skyler Ditchfield, Ventura, CA (US)

(73) Assignee: California Internet L.P., Ventura, CA (US)

(21) Appl. No.: 15/339,709

(22) Filed: Oct. 31, 2016

Related U.S. Application Data
(60) Provisional application No. 62/254,111, filed on Nov. 11, 2015.

(51) Int. Cl. H04W 16/14; H04B 1/707; H04W 16/28; H04L 5/22

(52) U.S. Cl. CPC H04W 16/14; H04L 5/22; H04B 1/707; H04W 16/28

(57) ABSTRACT

Apparati and methods for maximizing utilization of scarce radio frequency spectrum. An apparatus embodiment of the present invention comprises a first transmitter (1) adapted to transmit digital message streams over a single radio frequency using a multiplexing technique. A primary receiver (2) and at least one secondary receiver (3) are situated within radio reception range of the first transmitter (1). Each message stream is broken up into two logical streams. A first logical stream is dedicated to messages destined for the first receiver (2). A second logical stream is dedicated to messages destined for a secondary receiver (3). The first receiver (2) is enabled to receive only the first logical stream. The secondary receiver (3) is enabled to receive only the second logical stream. Thus, each receiver (2, 3) receives only those messages destined for said receiver (2, 3), respectively, thereby preserving confidentiality of the message content.

### RELATED APPLICATION

This patent application claims the priority benefit of U.S. provisional patent application 62/254,111 filed Nov. 11, 2015 (attorney docket CALI 0430 PR), which provisional patent application is hereby incorporated by reference in its entirety into the present patent application.

### TECHNICAL FIELD

This invention pertains to the field of transmission of multiplexed digital data modulated onto a radio frequency carrier.

### BACKGROUND ART

The radio spectrum is finite, and the geographical area available for fixed point to point (P2P) radio transmissions is also finite. Therefore, there is a continuing need to maximize throughput of digital data transmissions sent over radio frequencies. The invention described herein addresses this issue.

### DISCLOSURE OF INVENTION

The present invention comprises apparati and methods for maximizing utilization of scarce radio frequency spectrum. An apparatus embodiment of the present invention comprises a first transmitter (1) adapted to transmit digital message streams over a single radio frequency using a multiplexing technique. A primary receiver (2) and at least one secondary receiver (3) are situated within radio reception range of the first transmitter (1). Each message stream is broken up into two logical streams. A first logical stream is dedicated to messages destined for the first receiver (2). A second logical stream is dedicated to messages destined for a secondary receiver (3). The first receiver (2) is enabled to receive only the first logical stream. The secondary receiver (3) is enabled to receive only the second logical stream. Thus, each receiver (2, 3) receives only those messages destined for said receiver (2, 3), respectively, thereby preserving confidentiality of the message content.

### BRIEF DESCRIPTION OF THE DRAWINGS

These and other more detailed and specific objects and features of the present invention are more fully disclosed in the following specification, reference being had to the accompanying drawings, in which:

FIG. 1 is a top view planar sketch of an embodiment of the present invention.

FIG. 2 is a flow diagram illustrating a method embodiment of the present invention.

### DETAILED DESCRIPTION OF PREFERRED EMBODIMENTS

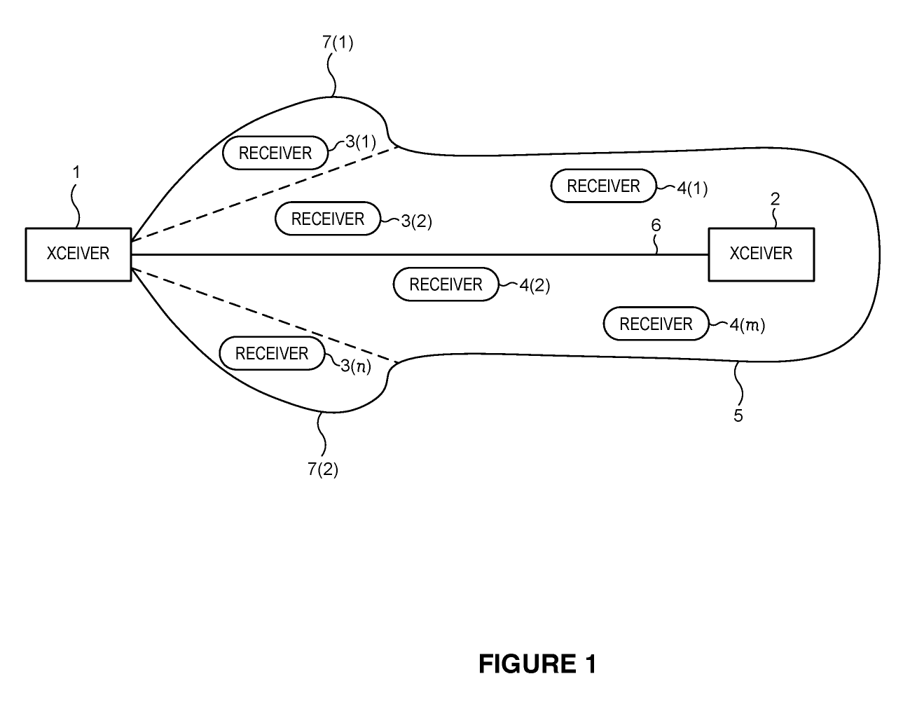

With reference to FIG. 1, a first transmitter 1 is configured to transmit digital message streams over a single radio frequency using a multiplexing technique. As used herein, “single radio frequency” is shorthand notation for “a radio frequency channel that does not change over time”. In practice, every radio transmission has a finite bandwidth, i.e., the transmission occupies a frequency channel having finite width. At the microwave frequencies typically employed by the present invention, the frequency channel is typically between 10 MHz and 50 MHz wide.

In the present invention, any modulation technique that inserts the digital data streams onto the RF carrier can be used.

The antenna pattern produced by transmitter 1 depends upon the frequency and upon the geometry of the transmitting antenna. As with all radio frequency transmissions that use a directional antenna, there is a main lobe 5 and one or more side lobes 7 in the radiation pattern. Directional antennas, such as flat panel antennas, are, in fact, typically used in the illustrated embodiment, to suppress radiation off the back of the antenna (to the left of transmitter 1 in FIG. 1). For a microwave frequency, the main lobe is typically 5 to 10 degrees wide, using a 3 dB threshold. In the example illustrated in FIG. 1, main lobe 5 has a generally cigar-shape pattern, and is roughly symmetrical about center line 6. Two side lobes 7 are present. In other embodiments, there can be more than two side lobes.

A primary receiver 2 and at least one secondary receiver 3 are situated within radio reception range of transmitter 1. Each message stream that is transmitted by transmitter 1 is broken up into two logical streams. A first logical message stream comprises only that content for which first receiver 2 is the desired recipient. A second logical message stream comprises only that content for which second receiver 3 is the desired recipient. The first receiver 2 is enabled to receive only the first logical message stream. The second receiver 3 is enabled to receive only the second logical message stream. Thus, each receiver 2, 3 receives only those messages that are meant for said receiver 2, 3, respectively. As a result, receiver 2 does not receive confidential messages that are intended to be received only by receiver 3, and receiver 3 does not receive confidential messages that are intended to be received only by receiver 2.

One or more of the secondary receivers 3 can lie within the main lobe 5, and one or more of the secondary receivers 3 can lie within a side lobe 7. In FIG. 1, receiver 3(2) lies within main lobe 5, receiver 3(1) lies within side lobe 7(1), and receiver 3(n) lies within side lobe 7(2). Each receiver 3 can be part of a transceiver, giving it the ability to transmit as well as receive.

In practice, transmitter 1 and receivers 2, 3 are typically each incorporated as part of a transceiver, i.e., each apparatus 1, 2, 3 has the capability to both transmit and receive on the same single frequency.

The single frequency that is used for the sending of the message streams by transmitter 1 is typically a microwave frequency that has been licensed by a cognizant government agency for point to point (P2P) communications. In most countries, the government agency is a national agency. In the United States, there are two cognizant agencies: the FCC (Federal Communications Commission) for commercial communications and the NTIA (National Telecommunications and Information Administration) for government communications. It is assumed that the apparatus shown in FIG. 1 has been properly licensed by the cognizant governmental agency for point to point (P2P) communications. For example, the FCC is responsible for issuing P2P licenses to operate in microwave frequency bands at or near 6 GHz, 11 GHz, 18 GHz, and 23 GHz.

In many embodiments, the multiplexing technique used by transmitter 1 is TDMA (Time Division Multiple Access). In other embodiments, the multiplexing technique is CDMA (Code Division Multiple Access). When CDMA is used, the particular CDMA technique can be direct sequence spread spectrum.

The timing of the multiplexing is adjusted, depending upon the number of receivers/transceivers 3 that are allowed into the network. For example, let us assume that there are three receivers 3, in addition to receiver 2, that are incorporated into the network. Let us assume that the multiplexing technique employed by the network is Time Division Multiple Access. Then the signals emanating from transceiver 1 can be broken up into four repeating intervals in the time domain. These intervals do not need to have equal length. For example, for each one second of transmission, the first 500 milliseconds can be a digital message stream dedicated for receiver 2. The next 300 milliseconds can be assigned to digital data destined for receiver 3(1). The next 200 milliseconds can be assigned to data destined for receiver 3(2). And the final 100 milliseconds can be assigned to data destined for receiver 3(n). This pattern is then repeated every second.

In those embodiments where receiver 2 is a transceiver, one or more additional receivers 4 may be inserted in the network to receive signals from transceiver 2. FIG. 1 illustrates that there are m additional receivers 4 that are allowed to receive signals emanating from transceiver 2 where m is an arbitrary positive integer. As with receivers 3, any one or more of receivers 4 can be part of transceivers, i.e., they have the ability to transmit as well as to receive radio signals at the same frequency.

The antenna pattern emanating from transceiver 2 is not shown in FIG. 1, to avoid cluttering FIG. 1. The intent of FIG. 1 is to illustrate that receiver 4(1) and receiver 4(m) are situated within side lobes of the antenna pattern emanating from transceiver 2, whereas receiver 4(2) is situated within the main lobe of the antenna pattern emanating from transceiver 2.

When the FCC issues licenses for point to point communications, it engages in a process of frequency coordination, which takes into account not just the frequency to be licensed, but also the geography of the primary communicating devices 1, 2. In this case, it is assumed that transceivers 1 and 2 are licensed by the FCC (or NTIA) to communicate with each other over a coordinated point to point frequency. A major goal of the coordination process is to minimize interference to stations that have already been licensed. This minimization of interference is typically defined in terms of a maximum level of signal strength (emanating from transceivers 1, 2) that existing stations are expected to tolerate. This maximum signal strength is usually expressed in dB over a defined geographical area. The geographical area is based upon the location of existing licensed stations that have already been authorized to operate at that frequency.

In the illustrated embodiment, receiver 3(2) is not subject to the government license enjoyed by transceivers 1 and 2. Thus, transceiver 3(2) is able to piggyback upon said license. This piggybacking technique can be extended to additional receivers beyond just receiver 3(2). In FIG. 1, a total of n piggybacking receivers 3 are shown, where n is an arbitrary positive integer. As with transceivers 1 and 2, receivers 3 can also be transceivers.

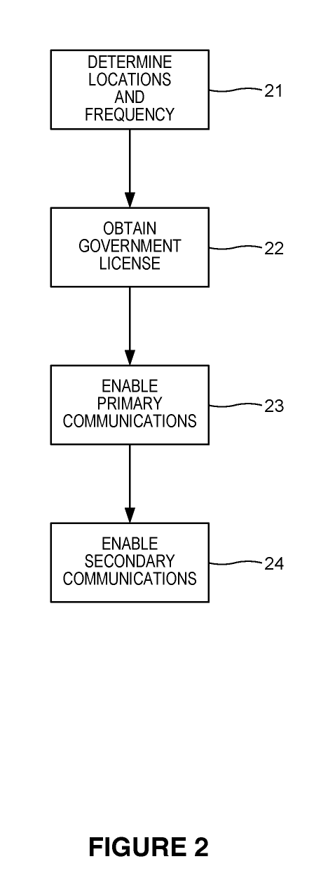

In practice, an operator wishing to use the inventive system depicted in FIG. 1 will first determine potential physical locations and a suitable frequency for transceivers 1, 2. Step 21 in FIG. 2. In making this determination, one criterion is that radio communications between transceivers 1, 2 are, in fact, possible at that frequency. This determination takes into account the geographical terrain, e.g., whether there are any obstructions between transceivers 1 and 2, and the distance between transceivers 1 and 2. At microwave frequencies, this distance is typically between 10 and 20 miles. A second criterion is that the proposed location and frequency will not result in unacceptable interference to existing stations. Once this preliminary determination of potential locations and frequency has been made, the operator seeks a license from the cognizant government agency, which performs its own analysis to verify the tentative conclusions reached by the seeking operator. Step 22 in FIG. 2.

The initial FCC license may be an experimental license, which may be followed by a full commercial license once the FCC becomes comfortable with the operation and is convinced that it is not causing unwanted interference to previously licensed stations.

Once approval has been received from the national government agency, the operator secures building permits and zoning permits from local government agencies if the operator is constructing a new installation. Alternatively, the operator may be installing transceiver 1 and/or transceiver 2 on existing towers or other structures. In that case, the operator's task is to negotiate an appropriate license giving the operator the right to construct and operate transceivers 1, 2 on the existing towers.

At step 23, the operator installs transceivers 1, 2 and associated equipment, such as antennas, and tests the ability of transceivers 1 and 2 to communicate with each other. The operator also investigates any interference to existing licensed stations. Once the primary communications link 1, 2 has been established, and the absence of unacceptable interference to existing licensed stations has been confirmed, the operator performs step 24, wherein other receivers 3 are allowed to receive signals from transceiver 1, and/or other receivers 4 are allowed to receive signals from transceiver 2.

By following the techniques of the present invention, a licensed P2P operation becomes in essence a P2MP (point to multipoint) operation. By using existing energy within a main lobe 5 or a side lobe 7 of a radiation beam, additional communication links (1 to 3 and/or 2 to 4) can be established, without causing any energy radiation outside of the non-interference zone that has been already cleared. Thus, the present invention makes more efficient use of scarce radio spectrum.

The above description is included to illustrate the operation of preferred embodiments, and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. Apparatus comprising:
a first transmitter adapted to transmit digital message streams over a single radio frequency using a multiplexing technique; and
a primary receiver and at least one secondary receiver situated within radio reception range of the first transmitter; wherein
each message stream is broken up into two logical streams, with a first logical stream dedicated to messages destined for the primary receiver, and a second logical stream dedicated to messages destined for a secondary receiver;
the primary receiver is enabled to receive only the first logical stream; and
the secondary receiver is enabled to receive only the second logical stream; whereby
each receiver receives only those messages destined for said primary or secondary receiver, respectively.

2. The apparatus of claim 1 wherein the frequency is a microwave frequency.

3. The apparatus of claim 1 wherein the first transmitter, the primary receiver, and at least one secondary receiver are each incorporated within a transceiver.

4. The apparatus of claim 1 wherein the first transmitter and the primary receiver are licensed by an authorized government agency to communicate over a coordinated Point To Point frequency.

5. The apparatus of claim 4 wherein no secondary receiver is licensed under said Point to Point coordination.

6. The apparatus of claim 1 wherein the multiplexing technique is Time Division Multiple Access.

7. The apparatus of claim 1 wherein the multiplexing technique is Code Division Multiple Access.

8. The apparatus of claim 7 wherein the Code Division Multiple Access comprises direct sequence spread spectrum.

9. The apparatus of claim 1 wherein the first transmitter produces a signal having a radiation pattern comprising a main lobe and at least one side lobe, and the primary receiver is situated within the main lobe.

10. The apparatus of claim 9 wherein at least one secondary receiver is situated within the main lobe.

11. The apparatus of claim 9 wherein at least one secondary receiver is situated within a side lobe.

12. The apparatus of claim 1 wherein:
the first transmitter is incorporated within a first transceiver;
the primary receiver is incorporated within a second transceiver; and
the second transceiver is adapted to transmit message streams over the same single radio frequency back to the first transceiver.

13. The apparatus of claim 12 further comprising a tertiary receiver situated within radio reception range of the second transceiver; wherein:
the secondary transceiver is adapted to transmit digital message streams over the same single radio frequency using a multiplexing technique;
each message stream emanating from the second transceiver is broken up into two logical streams, with a first logical stream dedicated to messages destined for the first transceiver, and a second logical stream dedicated to messages destined for the tertiary receiver;
the first transceiver is enabled to receive only the first logical stream; and
the tertiary receiver is enabled to receive only the second logical stream; whereby
each of the first transceiver and the tertiary receiver receives only those messages destined for said first transceiver or said tertiary receiver, respectively.

14. A method for maximizing utilization of scarce radio frequency spectrum, said method comprising the steps of:
determining physical locations and a suitable frequency band for a first transceiver and a second transceiver satisfying the criteria that radio communications between the first transceiver and the second transceiver within the frequency band are possible, and radio communications between the first transceiver and the second transceiver within the frequency band are not expected to generate unacceptable interference to existing licensed stations;
obtaining a license from a governmental agency for authorized Point To Point communications between the first transceiver and the second transceiver within the frequency band;
enabling radio communications between the first transceiver and the second transceiver within the frequency band using a multiplexing technique; and
inserting a third transceiver within radio communications range of at least one of the first transceiver and the second transceiver, said third transceiver enabled to communicate with at least one of said first transceiver and second transceiver within said frequency band.

15. The method of claim 14 wherein the step of obtaining a license comprises obtaining an experimental license, followed by obtaining a full commercial license.

16. The method of claim 14 wherein the multiplexing technique is Time Division Multiple Access.

17. The method of claim 14 wherein the multiplexing technique is Code Division Multiple Access.
